(19) United States
(12) Patent Application Publication
(10) Pub. No.: US 2005/0035311 A1
(43) Pub. Date: Feb. 17, 2005

(54) Inspection apparatus

(76) Inventors: Jin Asakawa, Nirasaki-shi (JP); Shuji Akiyama, Nirasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/845,246

(22) Filed: May 14, 2004

(30) Foreign Application Priority Data
May 16, 2003 (JP) 2003-138791

(51) Int. Cl. G01V 8/00; G01N 21/86

(52) U.S. Cl. 250/559.16; 250/559.45

(57) ABSTRACT

A stage (13) of the invention includes a stage substrate (13A) on which places at least one object (S1) to be inspected thereon, a light source (18) including a plurality of point light sources (18C) to illuminate the lower surface of the object to be inspected on the stage, and a diffusion mechanism (19) which diffuses light from the light source to irradiate the lower surface of the object. This stage can be suitably employed by an LCD panel inspection apparatus or image sensing element inspection apparatus.

### CROSS-REFERENCE TO RELATED APPLICATIONS

This application is based upon and claims the benefit of priority from prior Japanese Patent Application No. 2003-138791, filed May 16, 2003, the entire contents of which are incorporated herein by reference.

### BACKGROUND OF THE INVENTION

1. Field of the Invention

The present invention relates to a stage for an inspection apparatus and an inspection apparatus, and, more particularly, to a stage for an inspection apparatus and an inspection apparatus to detect whether or not an LCD panel or image sensing element is defective.

2. Description of the Related Art

To test the electrical characteristics, high-temperature characteristics, and the like of an LCD panel and image sensing element, testing and inspection are performed by means of separate inspection apparatuses. A case will be described wherein illuminated inspection of an LCD panel is performed. For example, an LCD substrate is manually mounted in an inspection socket and a signal from a signal generator such as a pattern generator is applied to the LCD panel through the socket. In this state, the rear surface of the LCD panel is illuminated to display an image on a screen. Whether or not a display defect is apparent in the image is checked visually.

With this inspection method, however, the inspection efficiency is poor and the cost of inspection is high. In addition, visual checking, being subjective, yields inspection results that vary depending on the inspector. In view of this, a technique which automatizes LCD substrate inspection is proposed by patent reference 1 (Jpn. Pat. Appln. KOKAI Publication No. 8-102476 (claim 1 and paragraphs [0034] to [0037])) and patent reference 2 (Jpn. Pat. Appln. KOKAI Publication No. 9-96825 (claim 2 and paragraphs [••12] to [••018])).

According to the technique of patent reference 1, alignment regions are formed on the left and right of the inspection region of an LCD substrate. Stages arranged on the respective alignment regions are alternately moved to the inspection region to increase the inspection efficiency of the LCD substrate. At the inspection region, an electrical signal for illuminated inspection is applied to the electrode terminals of the LCD panel through probes. With the LCD substrate being illuminated by backlights arranged in the stages, the LCD panel is sensed by a camera to perform illuminated inspection.

The technique of patent reference 2 includes probe terminals to be brought into contact with the respective electrode terminals of an LCD panel, a signal applying means for applying signals to the respective electrode terminals of the LCD panel from the probe terminals, an image capturing means for capturing a displayed image, an image processing means for processing the captured image, a defective display discriminating means for discriminating defective display of the LCD panel on the basis of the image-processed result, and a discriminating means for discriminating between defective contact of the electrode terminals of the LCD panel and the probe terminal and a defect of the LCD panel. When the image is to be captured, a backlight buried in a stage is used.

According to the conventional inspection apparatus for illuminated inspection, although the illuminated inspection for the LCD panel can be automatized, illumination of the LCD substrate using the backlight becomes nonuniform. The difference in brightness caused by the nonuniform illumination adversely affects the display image of the LCD panel, to make it difficult to detect a display defect correctly. Particularly, when the number of pixels of the LCD panel increases greatly to provide high definition recently, it is difficult to detect display unevenness accurately on the basis of a slight gradation change or the like. Then, an increase in inspection accuracy cannot be expected.

When environmental test such as high-temperature test is to be performed, a separate inspection apparatus must be used. Furthermore, it is difficult to illuminate image sensing elements formed on a substrate evenly with uniform brightness at a low cost, in the same manner as in the case of the LCD panel.

### BRIEF SUMMARY OF THE INVENTION

The present invention can employ various types of arrangements defined by the claims. The present invention solves one or a plurality of problems of the prior art to correspond to the employed arrangement.

According to the first aspect of the present invention, there is provided a stage for placing an object to be inspected thereon. The stage comprises:

a stage substrate to place at least one object to be inspected thereon;

a light source including a plurality of point light sources to illuminate a lower surface of the object to be inspected on the stage; and

a diffusion mechanism which diffuses light from the light source to irradiate the lower surface of the object to be inspected.

The stage according to the first aspect further preferably comprises any one or a plurality of the following items (a) to (c) in combination.

(a) A temperature control mechanism which controls a temperature of the stage substrate (the temperature control mechanism includes at least one of a mechanism which heats the stage substrate and a mechanism which cools the stage substrate).

(b) A heat shielding mechanism arranged between the temperature control mechanism and the light source.

(c) The stage substrate of the stage includes at least one opening in a region thereof where the object to be inspected is to be placed, and the opening is formed such that light irradiated from the diffusion mechanism irradiates the object to be inspected.

According to the second aspect of the present invention, there is provided an LCD inspection apparatus for testing characteristics of an LCD panel. The LCD inspection apparatus comprises:

a stage according to claim 1 (the stage serves to place at least one LCD panel thereon);

a signal application mechanism which applies a signal for illuminated inspection to the LCD panel; and

an image sensing mechanism which senses a surface of the LCD panel.

The LCD inspection apparatus according to the second aspect further preferably comprises any one or a plurality of the following items (d) to (j) in combination.

(d) A shield which surrounds the image sensing mechanism to shield external light.

(e) Among the plurality of point light sources, only a point light source to illuminate an image sensing element to be inspected is turned on.

(f) A temperature control mechanism which controls a temperature of a stage substrate (the temperature control mechanism includes at least one of a mechanism which heats the stage substrate and a mechanism which cools the stage substrate).

(g) A heat shielding mechanism arranged between the temperature control mechanism and light source.

(h) The stage substrate on the stage includes at least one opening in a region thereof where the LCD panel is to be placed, and the opening is formed such that light irradiated from the diffusion mechanism irradiates the LCD panel.

(i) The image sensing mechanism further includes a camera to photograph the LCD panel, and a moving mechanism to move the camera in at least one of X, Y, Z, and θ directions.

(j) The image sensing mechanism can move from a probe card to a retreat position.

According to the third aspect of the present invention, there is provided an inspection apparatus for testing electrical characteristics of at least one image sensing element. The inspection apparatus comprises:

a stage according to the first aspect (the stage serves to place an image sensing element thereon); and

a probe card which detects a signal from the image sensing element illuminated through a diffusion plate.

The inspection apparatus according to the third aspect further preferably comprises any one or a plurality of the following items (k) to (q) in combination.

(k) A power supply to apply power to the point light sources (the power supply can adjust its output power).

(l) The light source includes a white-emitting diode as the point light source.

(m) The light source is arranged in the stage.

(n) A temperature control mechanism which controls a temperature of the stage (the temperature control mechanism includes at least one of a mechanism which heats the stage substrate and a mechanism which cools the stage substrate).

(o) The temperature control mechanism further includes a heat shielding mechanism between the temperature control mechanism and light source.

(p) A stage substrate on the stage includes at least one opening in its region where the image sensing element is to be placed, and the opening is formed such that light irradiated from the diffusion mechanism irradiates the image sensing element.

(q) The stage is movable.

### BRIEF DESCRIPTION OF THE SEVERAL VIEWS OF THE DRAWING

FIG. 1 is a front view schematically showing an inspection apparatus according to the first embodiment of the present invention;

FIG. 2 is a schematic view showing the main part of the inspection apparatus shown in FIG. 1;

FIG. 3A is a plan view showing the main part of the stage shown in FIG. 1;

FIG. 3B is a sectional view showing the main part of the stage shown in FIG. 1;

FIG. 4 is a side view schematically showing an attached state of the CCD camera shown in FIG. 1;

FIG. 5 is a sectional view showing another embodiment of the inspection apparatus shown in FIG. 1;

FIG. 6 is a sectional view showing another arrangement of the inspection apparatus shown in FIG. 1;

FIG. 7 is a sectional view showing another arrangement of the inspection apparatus shown in FIG. 1;

FIG. 8 is a side view schematically showing another attached state of the CCD camera shown in FIG. 1;

FIG. 9 is a schematic view showing the main part of an inspection apparatus according to the second embodiment of the present invention;

FIG. 10 is a schematic view showing the main part of an inspection apparatus according to another second embodiment of the present invention;

FIG. 11 is a plan view of the coil heater shown in FIG. 10;

FIG. 12 is a sectional view showing another embodiment of the inspection apparatus shown in FIG. 9;

FIG. 13A is a view showing an embodiment of a stage substrate;

FIG. 13B is a sectional view of one embodiment of the stage substrate shown in FIG. 13A;

FIG. 13C is a sectional view of another embodiment of the stage substrate shown in FIG. 13A;

FIG. 13D is a sectional view of another embodiment of the stage substrate shown in FIG. 13A;

FIG. 14A is a view showing an embodiment of the stage substrate;

FIG. 14B is a sectional view of one embodiment of the stage substrate shown in FIG. 14A;

FIG. 14C is a sectional view of another embodiment of the stage substrate shown in FIG. 14A;

FIG. 14D is a sectional view of another embodiment of the stage substrate shown in FIG. 14A;

FIG. 15A is a view showing an embodiment of the stage substrate;

FIG. 15B is a sectional view of one embodiment of the stage substrate shown in FIG. 15A;

FIG. 16A is a view showing an embodiment of the stage substrate; and

FIG. 16B is a sectional view of one embodiment of the stage substrate shown in FIG. 16A.

### DETAILED DESCRIPTION OF THE INVENTION

The present invention relates to a stage for placing an object to be inspected thereon, an LCD inspection apparatus employing the stage, and an image sensing element inspection apparatus.

The stage can be employed not only by the LCD inspection apparatus or image sensing element inspection apparatus, but also by any other inspection apparatus that tests the characteristics of an object to be inspected while the object to be inspected is illuminated. For the descriptive convenience, in the following description, the stage will be described in describing the LCD inspection apparatus or image sensing element inspection apparatus which employs the stage described above.

[First Embodiment]

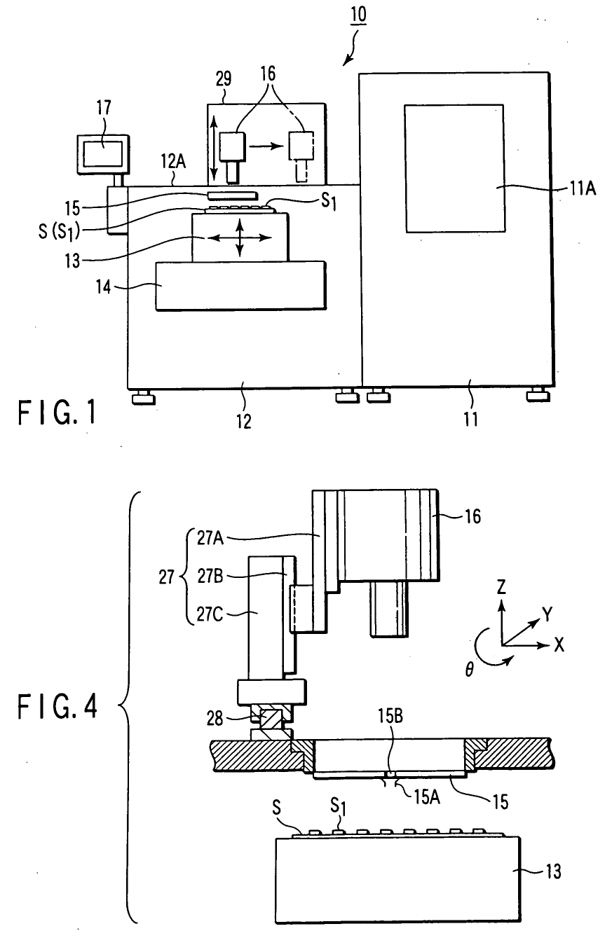

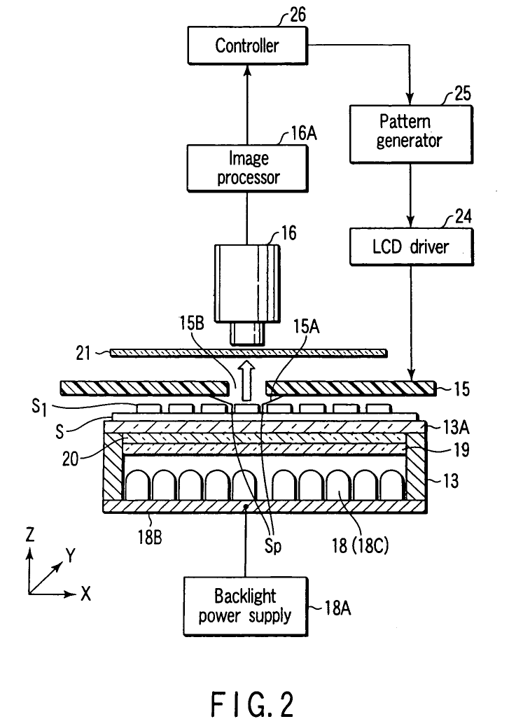

The inspection apparatus shown in FIG. 1 can be suitably used for, e.g., illuminated inspection for an LCD panel. This inspection apparatus 10 can include a loader chamber 11 which transports substrates (to be referred to as “LCD substrates” hereinafter) S on which LCD panels are formed, and a prober chamber 12 which is adjacent to the loader chamber 11 and in which illuminated inspection for the LCD substrates S is performed. The substrate can be a wafer-like substrate or a dicing-frame-like substrate. The LCD substrates S are transported from the loader chamber 11 into the prober chamber 12, and are subjected to illuminated inspection one by one in the prober chamber 12. Each LCD substrate S is a circular glass substrate with a diameter of 200 mm. Rectangular LCD panels S1 each with a side of approximately 20 mm can be arranged in a matrix on the upper surface of the LCD substrate S. Alternatively, one LCD panel S1 can be arranged on the LCD substrate S. A plurality of electrodes Sp (FIG. 2) which apply illuminated inspection signals can be arranged around each LCD panel S1.

The loader chamber 11 can include a transport mechanism (not shown) which transports the LCD substrate and a prealignment mechanism (not shown) which aligns the LCD substrate preliminarily. While the transport mechanism transports the LCD substrate S between the loader chamber 11 and prober chamber 12, the prealignment mechanism prealigns the LCD substrate S. Reference numeral 11A denotes a loading port through which the LCD substrate is loaded in the loader chamber 11. The loading port 11A can include an openable/closeable door (not shown).

As shown in FIG. 1, the prober chamber 12 includes a stage 13 for placing the LCD thereon and having an elevating mechanism which vertically moves the LCD substrate in the vertical direction (Z direction), an X-Y table 14 for supporting the stage 13 and moving it in the horizontal direction (X-Y direction), and an image sensing means (e.g., a CCD camera) 16 arranged above the stage 13. The X-Y table 14 is actuated to move the LCD substrate S on the stage 13 to right under a signal application mechanism (e.g., a probe card) 15. The stage 13 is then moved upward to bring probes 15A of the probe card 15 and the electrodes of the LCD panel S1 in contact with each other to perform illuminated inspection for the LCD panel S1. The image displayed on the LCD panel S1 is sensed through the CCD camera 16, and the sensed image is displayed on the display screen of a display device 17.

Although not shown in FIG. 1, an alignment mechanism is disposed in the prober chamber 12. The alignment mechanism accurately aligns the electrodes of the LCD panel S1 and the probes 15A of the probe card 15. During the alignment, target marks formed around the LCD panel S1 can be used.

As shown in FIG. 2, the stage 13 can be formed as a cylindrical metal vessel. A stage substrate 13A on the upper surface of the stage 13 can be formed of a circular transparent stage substrate (acrylic resin) 13A which transmits light. A large number of point light sources, white-emitting diodes, or other-color-emitting diodes, e.g., red-emitting diodes (to be merely referred to as LEDs hereinafter) 18 can be arranged in a matrix on the lower surface in the stage 13. Each LED or the like irradiates light. In FIG. 2, LEDs are indicated large, and their diameter can be about 3 mm, and their center-to-center distance can be about 5 mm.

The LEDs 18 are connected to a backlight power supply 18A. Preferably, the backlight power supply 18A turns on/off the LEDs 18 and controls their brightness. When controlling the brightness of the LEDs 18, preferably, the light quantity of the backlight is detected, and power to be supplied to the LEDs 18 is controlled on the basis of the light quantity.

As the LEDs 18, this apparatus uses mold-type LEDs mounted on a wiring board 18B. As the LEDs 18, LEDs other than mold-type LEDs, e.g., LEDs directly mounted on the surface of a wiring substrate may also be used.

A diffusion plate 19 for diffusing light evenly over its entire surface is arranged above the large number of LEDs 18. The diffusion plate 19 transmits irradiation light from the respective LEDs 18 upward with a uniform brightness distribution. A first polarizing plate 20 is arranged on the upper surface of the diffusion plate 19. The irradiation light from the LEDs 18 evenly illuminates the entire LCD panels S1 formed on the LCD substrate S with uniform brightness through the diffusion plate 19 and first polarizing plate 20.

As shown in FIG. 2, the probe card 15 has the plurality of probes 15A. The probes 15A may be arranged around a central opening 15B. A second polarizing plate 21 can be arranged between the probe card 15 and CCD camera 16. The illumination light from the LEDs 18 in the stage 13 is transmitted through the diffusion plate 19, first polarizing plate 20, transparent substrate 13A, and the corresponding LCD panel S₁ (as indicated by a hollow arrow), is transmitted through the second polarizing plate 21 via the opening of the probe card 15, and becomes incident on the CCD camera 16.

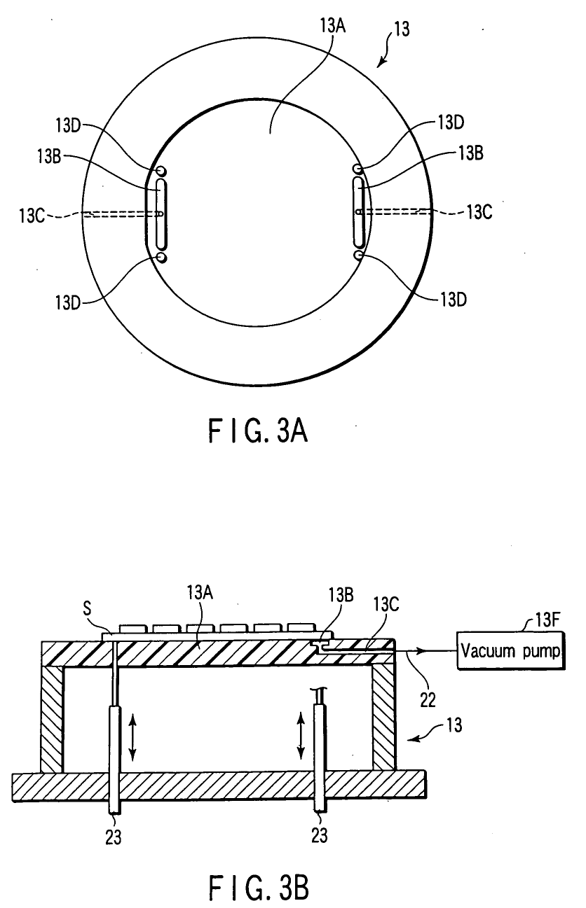

As shown in FIGS. 3A and 3B, two thin elongated chucking grooves 13B for chucking the LCD substrate S can be formed in the surface of the outer peripheral portion of the transparent substrate 13A. The chucking grooves 13B are arranged on the diametrically opposed sides.

An exhaust path 13C formed in the stage substrate 13A opens at the center in the longitudinal direction of each chucking groove 13B. The exhaust path 13C is connected to a vacuum exhaust device (13F) through a pipe 22. Through holes 13D through which respective elevating pins 23 extend are formed on the two sides in the longitudinal direction of each chucking groove 13B. When transferring the LCD substrate S, the elevating pins 23 move vertically on the surface of the stage 13. The elevating pins 23 are connected to each other under the stage 13, and are integrally moved vertically by a vertical driving mechanism (not shown), as indicated by arrows in FIG. 3B.

A plurality of connection terminals for applying the illuminated inspection signals are formed on the upper surface of the outer peripheral portion of the probe card 15. The connection terminals may be sequentially connected (FIG. 2) to an LCD driver 24 and signal generator (pattern generator) 25 through an interface (not shown). The LCD driver 24 and signal generator (pattern generator) 25 can be incorporated in the prober chamber 12, or can be arranged separately of the prober chamber 12.

The pattern generator 25 is controlled by a controller 26. Under the control of the controller 26, the pattern generator 25 generates various types of illuminated inspection signals. The signals are applied from the probe card 15 to the corresponding LCD panel S1 through the LCD driver 24.

The CCD camera 16 is connected to the controller 26 through an image processor 16A. An image displayed on the LCD panel S₁ when the illuminated inspection signals are applied is sensed by the CCD camera 16, and image information processed by the image processor 16A is loaded in the controller 26. The controller 26 includes a storage for storing a preset standard image, and an image checking portion for comparing the standard image and the sensed information from the CCD camera 16 to check whether or not the sensed image is defective.

As shown in FIG. 4, the CCD camera 16 can be supported by a support 27 to be vertically movable. The CCD camera 16 reciprocally moves, together with the support 27, between the central opening 15B of the probe card 15 and a retreat position (position indicated by an alternate long and short dashed line in FIG. 1) along a guide rail 28 on a head plate 12A.

More specifically, the support 27 has a first support 27A for supporting the CCD camera 16, and a second support 27C for supporting the first support 27A to be vertically movable along a guide rail 27B, and reciprocally moves on the guide rail 28 disposed on the head plate 12A. Although not shown, a knob for vertical manipulation is attached to the first support 27A. The image sensing position of the CCD camera 16 is adjusted through the knob.

Furthermore, as shown in, e.g., FIG. 1, the CCD camera 16 is preferably surrounded by a rectangular shield (hood) 29. External light is shielded by the hood 29, so that the LCD panel S₁, can be clearly sensed without being adversely affected by external light. When changing the probe card 15, the hood 29 is removed, the CCD camera 16 is retreated from immediately above the probe card 15, and then the probe card 15 is changed.

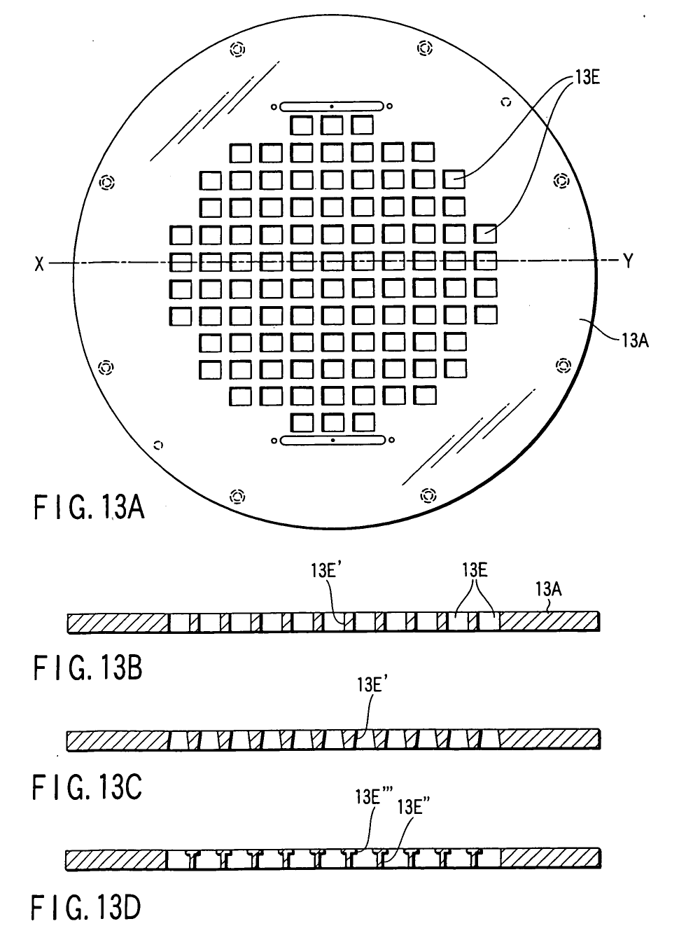

The stage 13 shown in FIG. 2 employs the transparent stage substrate 13A. However, the stage substrate is not limited to this. FIGS. 13A to 16B show stage substrates each having at least one opening in its region where the respective LCD panels S1 are to be arranged. The stage substrate need not be transparent, but can employ, e.g., a metal plate (e.g., one made of aluminum).

FIG. 13A shows a stage substrate 13A having a plurality of openings 13E. The respective openings 13E correspond to the positions and sizes of the respective LCD panels arranged on the LCD substrate. FIGS. 13B, 13C, and 13D show the sections of three types of stage substrates 13A, respectively. FIG. 13B shows a structure in which inner walls 13E′ of openings 13E are vertical walls. In the stage substrate 13A having this structure, neither dust attachment nor damage to the openings 13E occur. Thus, light from the diffusion plate 19 can irradiate the object to be inspected more evenly.

Inner walls 13E′ of openings 13E shown in FIG. 13C are inclined. Consequently, the openings have large bottom portions and narrow upper portions. The stage substrate having the openings 13E shown in FIG. 13C reflects light irradiated by the diffusion plate below it with the inclining inner surfaces of its openings, so that the light can irradiate the LCD more evenly.

Walls 13E″ which partition openings 13E shown in FIG. 13D have flanges 13E′″ at their upper portions. The flanges increase the sectional area of the openings while holding the strength of the openings 13E. Thus, much more light can be received from the diffusion plate.

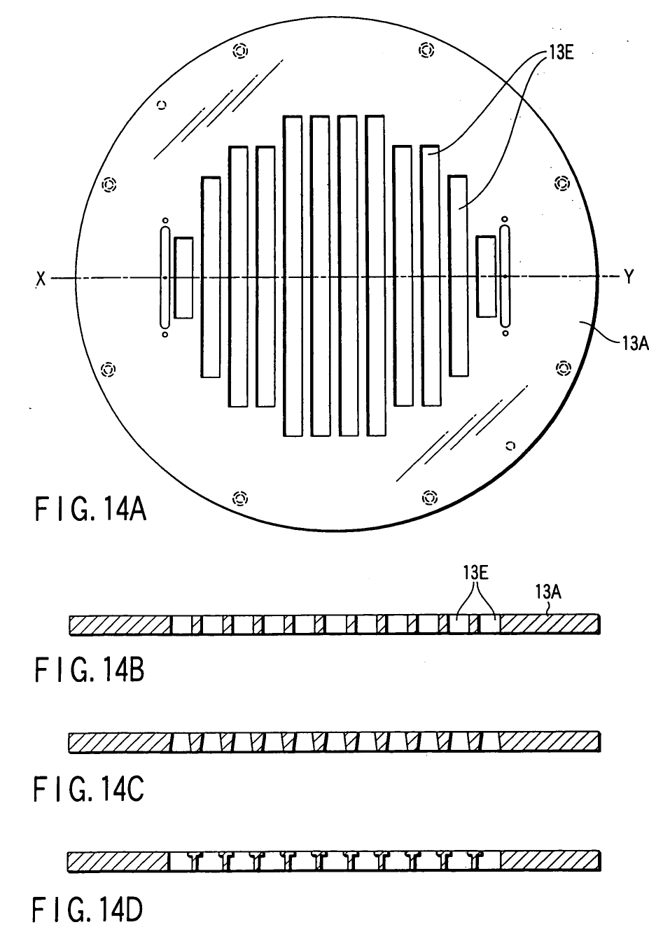

FIG. 14A shows a stage substrate having another structure. Openings 13E shown in FIG. 14A correspond to the positions and sizes of a plurality of LCD panels arranged in a row on an LCD substrate. The openings 13E can employ a sectional structure as shown in FIGS. 14B, 14C, or 14D. Although the stage substrates with these sectional structures have wide openings, they can basically achieve the same function as that of the stage substrates shown in FIGS. 13A to 13D.

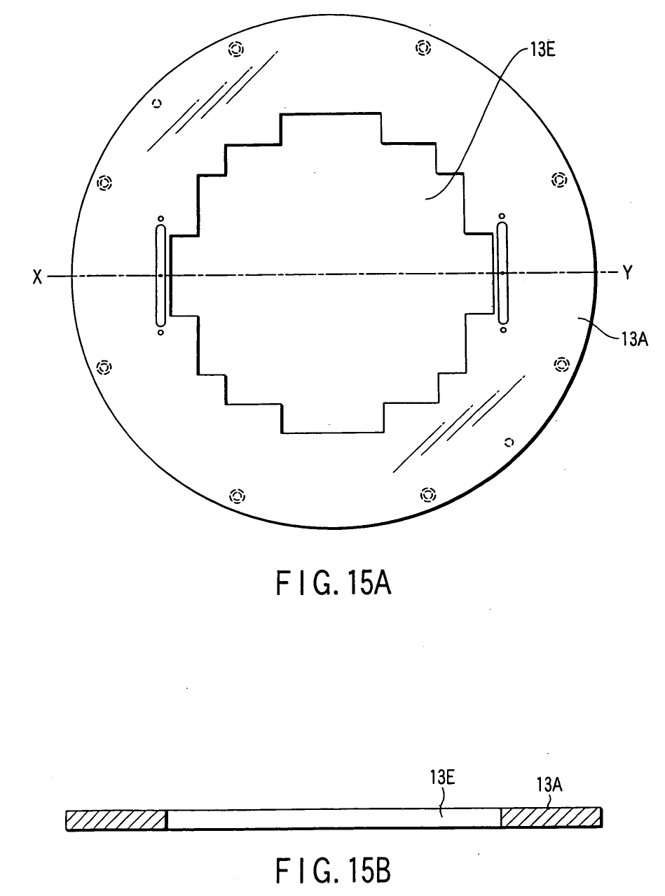

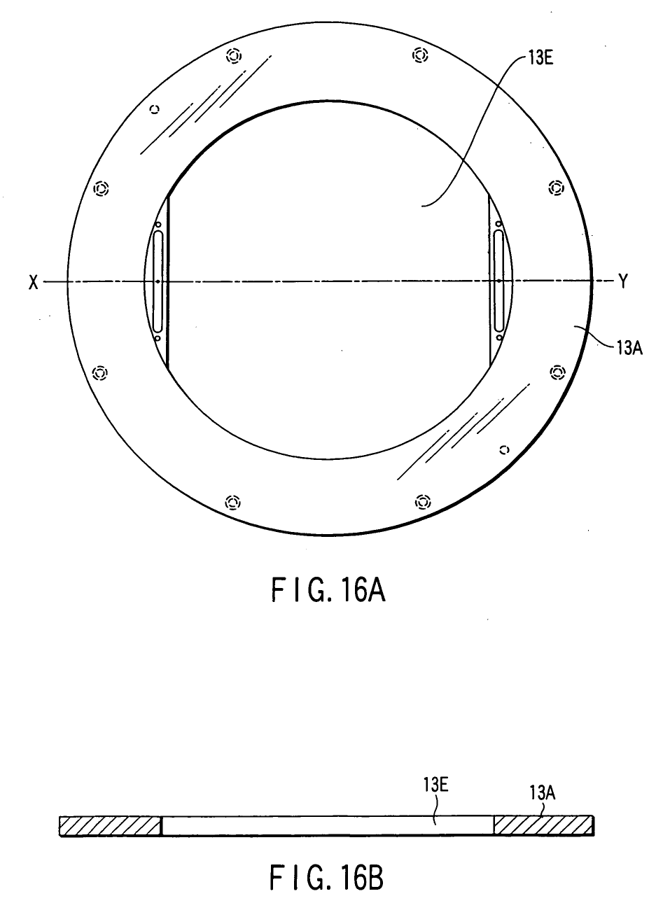

FIGS. 15A and 16A show stage substrates having other structures. Openings 13E shown in FIGS. 15A and 16A correspond to the positions and sizes of the entire region of a plurality of LCD panels arranged on an LCD substrate. The openings 13E of these stage substrates can be formed comparatively easily.

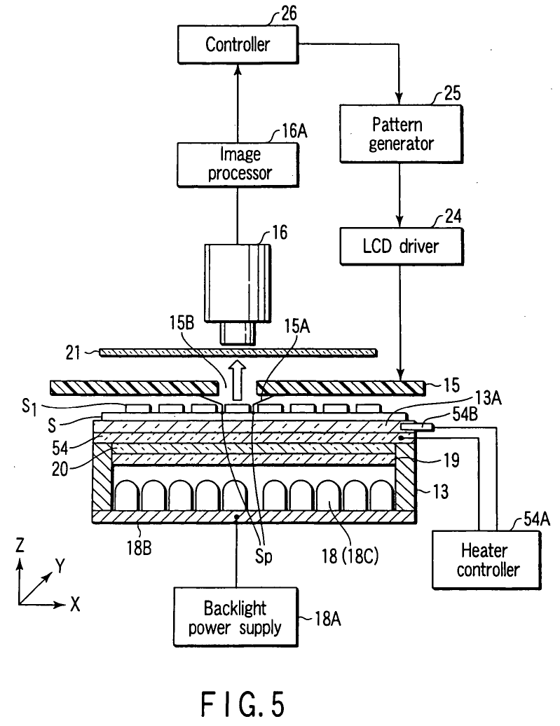

The stage 13 shown in FIG. 2 can inspect the LCD panels as objects to be inspected at room temperature. FIG. 5 shows a stage and inspection apparatus which enable inspection not only at room temperature but also at a predetermined temperature.

Referring to FIG. 5, a heating mechanism (heating plate) serving as a temperature control mechanism 54 is arranged under a stage substrate 13A of a stage 13. The heating mechanism 54 shown in FIG. 5 employs a transparent heating plate. A transparent resistor film made of Sn-doped In₂O₃ (ITO) or the like can be arranged on both or either surface of a glass substrate to form the transparent heating plate 54. As a method of arranging In₂O₃ on the glass substrate, the sputtering technique can be employed. When the sputtering technique is employed, the glass substrate can be coated with In₂O₃ evenly.

Accordingly, irradiation light from LEDs 18C can be transmitted through a diffusion plate 19, and the transparent heating plate 54 and stage substrate 13A to illuminate LCD panels S1 on an LCD substrate S evenly with uniform brightness.

The transparent heating plate 54 can be connected to a heater controller 54A. The heater controller 54A can be connected to a temperature sensor 54B mounted on the transparent substrate 13A. The heater controller 54A can control power to be supplied to the transparent heating plate 54 on the basis of the detection temperature of the temperature sensor 54B, to set the temperature of the LCD panels S1 of the LCD substrate S on the stage substrate 13A at a predetermined inspection temperature (e.g., 85° C.).

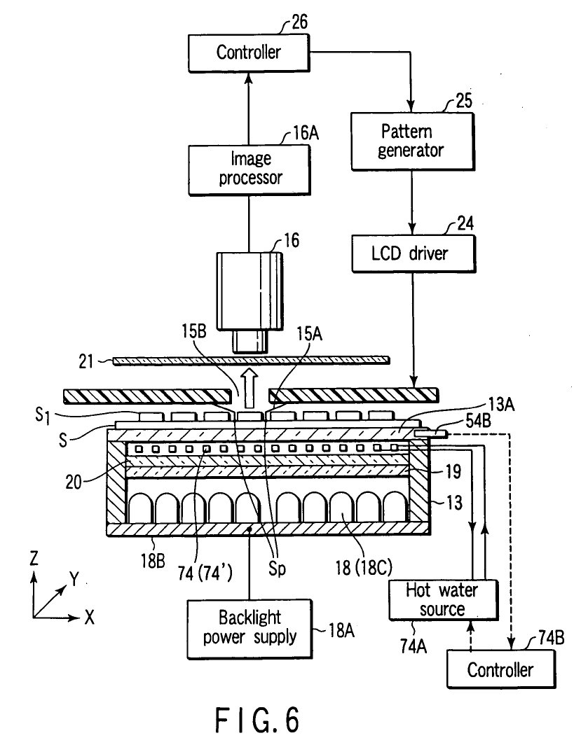

FIG. 6 shows a stage employing another heating mechanism 74. A stage 13 according to this embodiment includes a stage substrate 13A, a large number of LEDs 18C, diffusion plate 19, first polarizing plate 20, and the coil heater 74. Except for the coil heater 74, the stage 13 can be arranged in a manner similar to the stage and inspection apparatus shown in FIG. 5.

The coil heater 74 is arranged between the stage substrate 13A and diffusion plate 19. For example, hot water supplied by a hot water source 74A circulates through the coil heater 74 to heat the transparent substrate 13A and LCD panels S1 at a predetermined temperature. The hot water source 74A is connected to a controller 74B, and the controller 74B is connected to a temperature sensor 54B mounted on the transparent substrate 13A. Therefore, the controller 74B controls the hot water source 74A on the basis of the detection temperature of the temperature sensor 54B, to control the temperature and flow rate of the hot water circulating through the coil heater 74. Thus, the temperature of the LCD panels S1 is controlled.

As the temperature control mechanism, a cooling coil 74′ similar to the coil heater 74 can also be provided. When providing the cooling coil 74′ as well, the temperature and flow rate of cold water to be. supplied to the cooling coil 74′ are controlled, so that the temperature of the LCD panels S1 can be decreased.

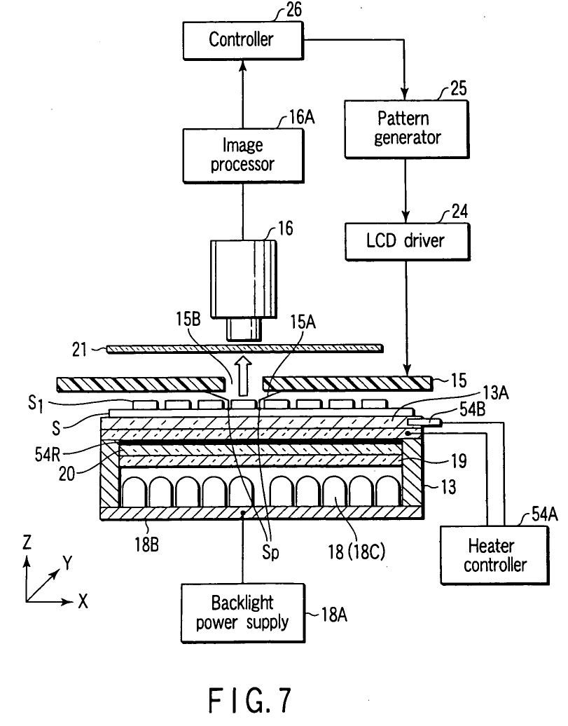

FIG. 7 shows a stage 13 having a heat shielding mechanism 54R, and an inspection apparatus. The heat shielding mechanism 54R is arranged between a temperature control mechanism 54 and light sources 18 to limit or decrease transfer of heat between them. In a preferred embodiment, the heat shielding mechanism 54R is arranged between a heating plate 54 serving as a temperature control mechanism and a diffusion plate 19 (or first polarizing plate 20).

The heat shielding mechanism 54R can employ a structure in which a material with low thermal conductivity (e.g., air) is arranged in the space between the heating plate 54 and diffusion plate 19 (or first polarizing plate 20), a structure in which this space forms a closed vacuum space, a structure in which another sealed space structure is arranged in this space, a structure in which the interior of the sealed space structure is vacuum, or the like. In fine, the heat shielding mechanism 54R can employ any mechanism that can decrease heat transfer between the temperature control mechanism 54 and light sources 18. When the heat shielding mechanism 54R is employed, even when LEDs having low heat resistance are employed as the light sources, degradation of the LEDs can be decreased.

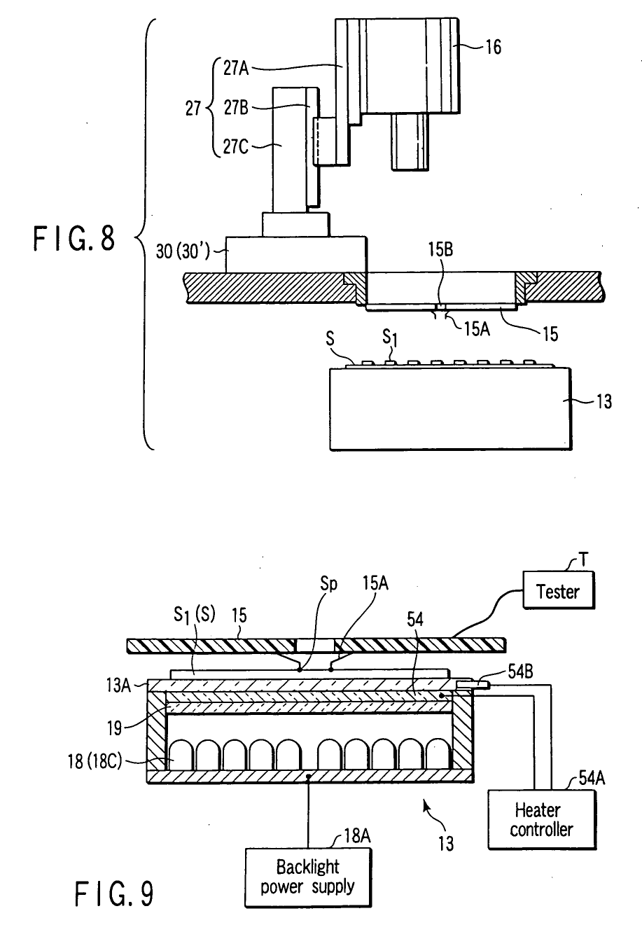

FIG. 8 shows a photographing mechanism according to another embodiment. In the photographing mechanism 27 shown in FIG. 4, the CCD camera 16 can move only in the Z and Y directions. A photographing mechanism 27 shown in FIG. 8 includes an X-Y moving mechanism 30. The X-Y moving mechanism 30 can move a camera 16 in the X or Y direction. When the camera 16 is moved in the X or Y direction by the X-Y moving mechanism 30, the optical axis for photographing of the camera 16 can be aligned with probes 15A of a probe card 15.

When an X-Y-θ moving mechanism 30′ is employed in place of the X-Y moving mechanism 30, the camera 16 can move in the X, Y, and θ directions.

The operation will be described. Referring to FIG. 1, the LCD substrates S in a cassette are loaded into the loader chamber 11. In the loader chamber 11, the transport mechanism unloads each LCD substrate S from the cassette. The prealignment mechanism prealigns the LCD substrate S. After that, the transport mechanism transports the LCD substrate S to the prober chamber 12.

During this period of time, in the prober chamber 12, the stage 13 stands by at a predetermined position. When the LCD substrate S is loaded from the loader chamber 11 into the prober chamber 12, the elevating pins 23 project from the surface of the stage 13 to receive the LCD substrate S from the transport mechanism (FIG. 3B). When the elevating pins 23 receive the LCD substrate S, they move downward into the stage 13 to place the LCD substrate S on the stage 13. The vacuum exhaust device 13F evacuates air between the chucking grooves 13B and LCD substrate S through the exhaust path 13C. The interiors of the chucking grooves 13B are pressure-reduced, and the LCD substrate S is drawn onto the stage 13 by vacuum. In FIG. 2, the backlight power supply 18A supplies power to the LEDs 18, and the LEDs 18 illuminate the LCD substrate S. At this time, preferably, the voltage of the backlight power supply 18A is appropriately adjusted in accordance with the type of the LCD substrate S, to appropriately control the illuminance of the LEDs 18.

The LEDs 18 are preferably arranged dispersedly in the entire stage 13 evenly. Even when the respective LEDs 18 are point light sources, light from the LEDs 18 is diffused by the diffusion plate 19. Consequently, uniform illumination light from the entire surface of the diffusion plate 19 becomes incident on the first polarizing plate 20. Light polarized by the first polarizing plate 20 illuminates the LCD panels S1. Therefore, the respective LEDs 18 evenly, uniformly illuminate all the LCD panels S1 through the diffusion plate 19. As a result, any LCD panel S1 can clearly display an image that precisely reflects a slight gradation difference. The CCD camera 16, partly because of the operation of the hood 29, can clearly sense the image displayed on the LCD panel S1 through the second polarizing plate 21.

After that, while the stage 13 moves on the X-Y table 14 in the X-Y direction, the electrodes of the LCD panel S1 on the stage 13 and the probes 15A of the probe card 15 are aligned through the alignment mechanism (FIG. 1). When performing alignment, it is preferable to use target marks formed on the LCD panel S1. After the alignment, the stage 13 moves on the X-Y table 14, to position the LCD panel S1 that should be inspected first to immediately below the probe card 15. When the stage 13 moves upward, the respective electrodes of the LCD panel S1 come into electrical contact with the corresponding probes 15A.

Under the control of the controller 26 (FIG. 2), the pattern generator 25 generates illuminated inspection signals. The signals are applied to the LCD panels S1 through the LCD driver 24, and the LCD panels S1 display images having various types of patterns. At this time, the brightness of the illumination light from the LEDs 18 is uniformed by the entire surface of the diffusion plate 19, to irradiate the lower surface of the LCD substrate S through the first polarizing plate 20 and transparent substrate 13A. The light from the LCD panel S1 transmitted through the central opening 15B of the probe card 15 is polarized by the second polarizing plate 21. The CCD camera 16 senses the transmission light (display images of the LCD panel S1) from the second polarizing plate 21. The image processor 16A processes the sensed image and outputs it to the controller 26.

The controller 26 compares the standard image and the image information loaded from the image processor 16A, and checks whether or not the sensed image is defective. At this time, the entire surface of the LCD panel S1 at any portion of the LCD substrate S is illuminated with uniform brightness. Thus, a slight display defect of each LCD panel S1 can be reliably detected by the CCD camera 16 without failure. In other words, the image information and standard image are compared, and a defect of the image information can be detected and grasped reliably.

The stage 13 is moved to perform illuminated inspection for the next LCD panel S1. The inspection results of all the LCD panels S1 are finally displayed by mapping on the display screen of the display device 17.

In the embodiment described above, as shown in FIGS. 5 or 6, the temperature control mechanism 54 is preferably built in the stage 13. The temperature control mechanism 54 heats or cools the LCD panels S1 through the stage substrate 13A. The LCD panels S1 can be subjected to the above inspection while being heated or cooled.

As shown in FIG. 7, when the stage 13 includes the heat shielding mechanism 54R as well as the temperature control mechanism 54, the function of the temperature control mechanism 54 to heat or cool the LEDs 18 is suppressed, and the temperature control mechanism 54 can heat or cool the LCD panels S1 efficiently. Furthermore, since the LEDs 18 are suppressed from being heated by the temperature control mechanism 54, their service life can be prolonged.

Furthermore, as shown in FIG. 8, when the moving mechanism 30 (30′) which moves the camera 16 in the X and Y directions or in the X, Y, and θ directions is employed, the camera 16 can be moved in the X and Y directions or in the X, Y, and θ directions, to align the optical axis of the camera 16 with an opening 15B of the probe card 15 accurately and easily.

As described above, in the embodiments shown in FIGS. 1 to 8 and FIGS. 13A to 16B, the entire surface of the LCD substrate S can be illuminated evenly with uniform brightness. Thus, an image defect of high-definition LCD panels S1 can be detected automatically, accurately, and reliably.

According to this embodiment, since small point light sources are used as the light source, the light source portion can be downsized. Since the LEDs 18 such as LEDs are used as the point light sources, the service life of the light source can be prolonged (semipermanently), and power consumption can be economized.

Control operation can be performed to turn on only a point light source, among a large number of point light sources, that illuminates the LCD panel S1 to which a illuminated inspection signal is applied. Then, power consumption can be economized.

The backlight power supply 18A which adjusts power to be applied to the LEDs 18 can be provided. Then, the brightness of the LEDs 18 can be controlled in accordance with the type of the LCD panels S1 and how the LCD panels S1 are to be actually used.

According to this embodiment, the hood 29 which surrounds the CCD camera 16 to shield external light is provided. Thus, the LCD panels S1 can display clear images without being influenced by the external light. More reliable, accurate illuminated inspection can accordingly be performed.

The CCD camera 16 can move from the probe card 15 to the retreat position. Thus, the probe card 15 can be changed easily in accordance with the type of the LCD substrate S.

The transparent heating plate 54 can be incorporated in the stage 13. Then, the LCD panels S1 can be inspected while they are heated or cooled.

The heat shielding mechanism 54R can be provided. Then, the temperature control mechanism 54 can heat or cool the LCD panels S1 efficiently. The LEDs 18 are suppressed from being heated by the temperature control mechanism 54. Consequently, the service life of the LEDs 18 can be prolonged.

The moving mechanism 30 (30′) for moving the camera 16 in the X and Y directions or in the X, Y, and θ directions can be provided. Then, the optical axis of the camera 16 can be aligned with the opening 15B of the probe card 15 accurately and easily.

[Second Embodiment]

FIG. 9 is a view showing the main part of another embodiment of the present invention. This embodiment exemplifies an inspection apparatus suitably used for light-reception test for an image sensing element. The inspection apparatus according to this embodiment can include a loader chamber 11 for transporting a substrate (to be referred to as a “CCD substrate” hereinafter) on which a plurality of image sensing elements (e.g., CCD-type image sensing elements or MOS-type image sensing elements) S are formed, and a prober chamber 12 adjacent to the loader chamber to perform light-reception test for the CCD substrate. The loader chamber 11 can be formed in a manner similar to that of the LCD inspection apparatus shown in FIG. 1. Other than a wafer-type substrate, a dicing-type substrate can also be employed as the CCD substrate.

As shown in, e.g., FIG. 9, the prober chamber can include a stage 13, a probe card 15 arranged above the stage 13, and a tester T electrically connected to the probe card 15. When the stage 13 moves in the horizontal and vertical directions (FIG. 1), respective image sensing elements S1 on a substrate S on the stage 13 are subjected to light-reception test with their electrodes Sp being in electrical contact with probes 15A of the probe card 15. Light-reception test refers to a test in which, when a light-receiving portion formed on the lower surface of the substrate S is illuminated, signals are derived from the electrodes of the image sensing elements S1 formed on the upper surface of the substrate S to test the function of the image sensing elements.

As shown in FIG. 9, the stage 13 can be formed as a cylindrical metal vessel. A stage substrate (e.g., an acrylic-resin transparent substrate or a substrate having an opening) 13A which transmits light is arranged on the upper surface of the stage 13.

The stage substrate 13A preferably includes vacuum chucking means 13B, 13C, and 13F (FIG. 3) for drawing the substrate S by vacuum, in the same manner as in the above embodiment. Point light sources, e.g., a plurality of white-emitting diodes or other-color-emitting diodes such as red-emitting diodes (to be merely referred to as LEDs hereinafter) 18C are arranged (e.g., in a matrix) in the lower portion in the stage 13. As the LEDs 18C, ones which are identical to those employed in the first embodiment can be employed. Preferably, a backlight power supply 18A turns on/off the LEDs 18C and controls their brightness.

A diffusion plate 19 is arranged above the large number of LEDs 18C. The diffusion plate 19 diffuses irradiation light from the LEDs 18C to irradiate upward with uniform brightness.

A temperature control mechanism (e.g., transparent heating plate) 54 is preferably arranged under the stage substrate 13A. The temperature control mechanism 54 preferably includes a heating mechanism for heating the image sensing elements S1 and/or a cooling mechanism for cooling the image sensing elements S1. FIG. 9 shows a transparent heating plate 54 as an example of the heating mechanism 54.

A transparent resistor film made of Sn-doped In₂O₃ (ITO) or the like can be arranged on both or either surface of a glass substrate to form the transparent heating plate 54. As a method of arranging In₂O₃ on the glass substrate, the sputtering technique can be employed. When the sputtering technique is employed, the glass substrate can be coated with In₂O₃ evenly.

Irradiation light from LEDs 18C is transmitted through the diffusion plate 19, transparent heating plate 54, and stage substrate 13A to illuminate the image sensing elements on the substrate S evenly with uniform brightness.

The transparent heating plate 54 is controlled by a heater controller 54A. The heater controller 54A preferably includes a temperature sensor 54B mounted on the transparent substrate 13A. The heater controller 54A controls the temperature of the transparent heating plate 54 on the basis of the detection temperature of the temperature sensor 54B. The temperature of the image sensing elements S1 on the substrate S placed on the stage substrate 13A can be set to temperature for high-temperature inspection (e.g., 85° C.).

FIGS. 10 and 11 show a stage employing another heating mechanism 74. A stage 13 according to this embodiment includes a stage substrate 13A, a large number of LEDs 18C, diffusion plate 19, first polarizing plate 20, and coil heater 74. Except for the coil heater 74, the stage 13 can be formed in the similar manner to the stage and inspection apparatus shown in FIG. 9.

The heating mechanism 74 is basically the same as that described with reference to FIG. 6 of the first embodiment.

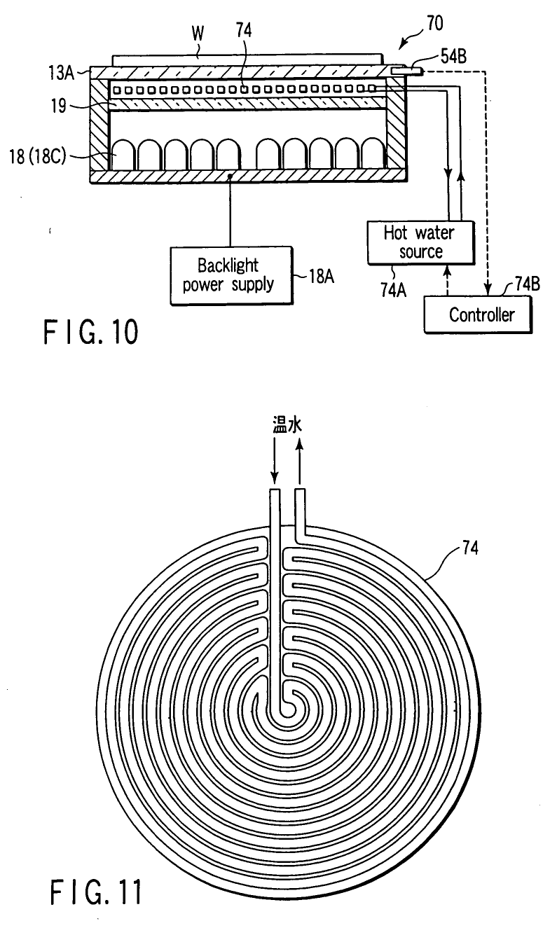

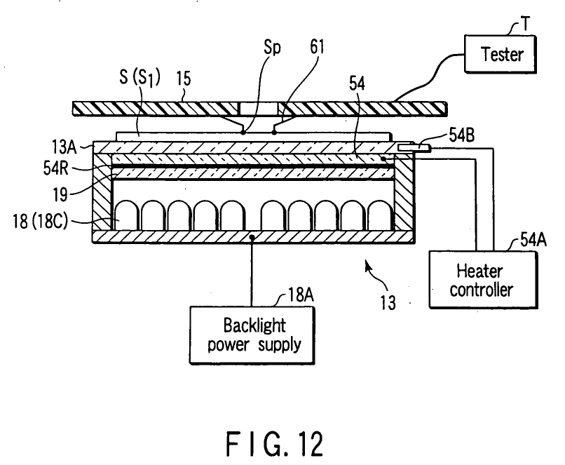

FIG. 12 shows an inspection apparatus which further includes a heat shielding mechanism 54R. The heat shielding mechanism 54R can employ the structure of the first embodiment described in detail with reference to FIG. 7. The function of the heat shielding mechanism 54R is the same as that described above.

The stage 13 shown in FIG. 9 employs the transparent stage substrate 13A. However, the stage substrate 13A is not limited to this. The stage substrate 13A having any one of the structures shown in FIGS. 13A to 16B can be employed in the second embodiment as well. The function of a case in which such stage substrate 13A is employed in the second embodiment is the same as that described in the first embodiment.

The operation will be described.

The substrate S is transported from the loader chamber 11 onto the stage 13 in the prober chamber 12 (FIG. 1). Vacuum chucking means 13B, 13C, and 13F (FIG. 3) of the stage 13 draw the substrate S by vacuum onto the stage substrate 13A. Subsequently, the stage 13 moves in the horizontal direction to align the electrodes of an image sensing element S1 that should be inspected first of the substrate S on the stage substrate 13A and the probes 15A of the probe card 15.

After that, the stage 13 moves upward, so that the respective electrodes Sp of the image sensing element S1 come into electrical contact with the corresponding probes 15A.

At this time, the backlight power supply 18A supplies power to the LEDs 18C to illuminate the substrate S. Even if the respective LEDs 18C are point light sources, illumination light from the respective LEDs 18C is diffused by the diffusion plate 19, so that uniform illumination light is radiated from the entire surface of the diffusion plate 19. The light is transmitted through the temperature control mechanism (transparent heating plate) 54 and stage substrate 13A to illuminate the entire surface of the substrate S uniformly and evenly. At this time, preferably, the voltage of the backlight power supply 18A is appropriately adjusted when necessary, to appropriately control the illuminance of the LEDs 18. This illumination is received by the light-receiving portion of the image sensing elements S1, and signals corresponding to the brightness of the illumination are output from the electrodes Sp of the image sensing elements S1. The tester detects this output through the probes 15A, and tests functions such as electrical characteristics of the corresponding image sensing element S1. After that, the stage 13 moves downward, and the following image sensing elements S1 are tested sequentially.

When high- or low-temperature inspection is to be performed, the temperature control mechanism 54 heats (e.g., 85° C.) or cools the image sensing elements S1 under the control of the heater controller 54A on the basis of the temperature detected by the temperature sensor 54B. Light-reception test for the temperature-controlled image sensing elements S1 is performed in this manner.

As described above, according to the second embodiment shown in FIGS. 9 to 16B, the entire surface of the substrate S can be illuminated evenly with uniform brightness, to perform light-reception test for the plurality of image sensing elements S1 automatically. In addition, stable, high-reliability test can be performed for each image sensing element S1.

According to this embodiment, since the temperature control mechanism (e.g., transparent heating plate) 54 is provided to heat the image sensing elements S1, light-reception test and high- or low-temperature inspection can be performed with one inspection apparatus. In addition, variations in the inspection results can be suppressed or prevented.

Therefore, unlike in the conventional case, no inspection apparatuses need be provided exclusively for light-reception test and high- or low-temperature inspection, so that the cost of equipment and inspection cost can be decreased.

The same function and effect as those of the first embodiment described above can be expected.

FIG. 10 shows the main part of an inspection apparatus according to still another embodiment. This inspection apparatus is suitably used in light-reception test for image sensing elements S1 in the same manner as the inspection apparatus shown in FIG. 9. A stage 13 of this embodiment includes a stage substrate 13A, a large number of LEDs 18C, diffusion plate 19, and coil heater 74. Except for the coil heater 74, this inspection apparatus can be formed in a manner similar to that shown in FIG. 9.

The coil heater 74 is preferably arranged between the stage substrate 13A and diffusion plate 19. The coil heater 74 is connected to, e.g., a hot water source 74A. Hot water supplied by the hot water source 74A circulates through the coil heater 74 to heat a substrate S at a predetermined temperature through the stage substrate 13A. The hot water source 74A is connected to a controller 74B, and the controller 74B is connected to a temperature sensor 74C mounted on the stage substrate 13A. The controller 74B controls the hot water source 74A on the basis of the detection temperature of the temperature sensor 74C, to control the temperature and flow rate of the hot water circulating through the coil heater 74. Thus, the temperature of the LCD panels S1 is controlled.

In this embodiment as well, light-reception test and high- or low-temperature inspection for the respective image sensing elements S1 of the substrate S can be performed with one inspection apparatus, in the same manner as in the first embodiment described above.

In light-reception test, when illumination light from the large number of LEDs 18C is transmitted through the stage substrate 13A, the coil heater 74 forms the shadow of the LEDs 18C. Consequently, the substrate S is irradiated unevenly. In order to suppress this defect, another diffusion plate may be arranged between the coil heater 74 and stage substrate 13A.

The present invention is not limited to the embodiments described above, but the design of respective constituent elements can be changed when necessary. For example, while the LEDs 18 are arranged in a matrix in the above embodiments, another arrangement can be employed. The point light sources can be controlled to irradiate only an image sensing element portion that detects a signal for light-reception test. While the point light sources are exemplified by the LEDs, other point light sources can be used. The heating means is not limited to the heating means of the embodiments shown in FIGS. 9 to 12, but its design can be changed when necessary. For example, the transparent heating plate can use a transparent resistor film other than an ITO film. In the embodiment shown in FIG. 10, hot water is used as the heat medium. However, another heat medium such as air can be used. Heat generated by the point light sources such as LEDs can be used as the heating means. Furthermore, the image sensing elements are not limited to CCD-type elements, but the present invention can also be applied to MOS-type elements.

According to the embodiments of the present invention, an inspection apparatus that can detect an image defect of a high-definition LCD panel automatically, accurately, and reliably can be provided.

According to the embodiments of the present invention, an inspection apparatus that can perform light-reception test for image sensing elements at a low cost with high reliability can be provided.

When the heat shielding mechanism 54R is provided, the transparent heating plate 54 can heat or cool the image sensing elements S1 efficiently. The LEDs 18 are suppressed from being heated by the transparent heating plate 54. Thus, the service life of the LEDs 18 can be prolonged.

1. A stage for placing an object to be inspected thereon, comprising:
a stage substrate to place at least one object to be inspected thereon;
a light source including a plurality of point light sources to illuminate a lower surface of the object to be inspected on the stage; and
a diffusion mechanism which diffuses light from the light source to irradiate the lower surface of the object to be inspected.

2. A stage according to claim 1, further comprising a temperature control mechanism which controls a temperature of the stage substrate, wherein the temperature control mechanism includes at least one of a mechanism which heats the stage substrate and a mechanism which cools the stage substrate.

3. A stage according to claim 2, wherein the temperature control mechanism further includes a heat shielding mechanism between the temperature control mechanism and the light source.

4. A stage according to claim 1, wherein the stage substrate of the stage includes at least one opening in a region thereof where the object to be inspected is to be placed, and the opening is formed such that light irradiated from the diffusion mechanism irradiates the object to be inspected.

5. An LCD inspection apparatus for testing characteristics of an LCD panel, comprising:
a stage according to claim 1, the stage serving to place at least one LCD panel thereon;
a signal application mechanism which applies a signal for illuminated inspection to the LCD panel; and
an image sensing mechanism which senses a surface of the LCD panel.

6. An inspection apparatus according to claim 5, further including a shield which surrounds the image sensing mechanism to shield external light.

7. An inspection apparatus according to claim 5 wherein, among the plurality of point light sources, only a point light source to illuminate an image sensing element to be inspected is turned on.

8. An inspection apparatus according to claim 5, further comprising a temperature control mechanism which controls a temperature of the stage substrate, wherein the temperature control mechanism includes at least one of a mechanism which heats the stage substrate and a mechanism which cools the stage substrate.

9. An inspection apparatus according to claim 8, wherein the temperature control mechanism further includes a heat shielding mechanism between the temperature control mechanism and the light source.

10. An inspection apparatus according to claim 5, wherein the stage substrate on the stage includes at least one opening in a region thereof where the LCD panel is to be placed, and the opening is formed such that light irradiated from the diffusion mechanism irradiates the LCD panel.

11. An inspection apparatus according to claim 5, wherein the image sensing mechanism further includes:
a camera to photograph the LCD panel; and
a moving mechanism to move the camera in at least one of X, Y, Z, and θ directions.

12. An inspection apparatus for testing electrical characteristics of at least one image sensing element, comprising:
a stage according to claim 1, the stage serving to place the image sensing element thereon; and
a probe card which detects a signal from the image sensing element illuminated through a diffusion plate.

13. An inspection apparatus according to claim 12, further including a power supply to apply power to the point light sources, wherein the power supply can adjust output power thereof.

14. An inspection apparatus according to claim 12, wherein the light source includes a white-emitting diode as the point light source.

15. An inspection apparatus according to claim 12, wherein the light source is arranged in the stage.

16. An inspection apparatus according to claim 12, further comprising a temperature control mechanism which controls a temperature of the stage, wherein the temperature control mechanism includes at least one of a mechanism which heats the stage substrate and a mechanism which cools the stage substrate.

17. An inspection apparatus according to claim 12, wherein the temperature control mechanism further includes a heat shielding mechanism between the temperature control mechanism and the light source.

18. An inspection apparatus according to claim 12, wherein the stage substrate on the stage includes at least one opening in a region thereof where the image sensing element is to be placed, and the opening is formed such that light irradiated from the diffusion mechanism irradiates the image sensing element.
